(19) United States
(12) Patent Application Publication
(10) Pub. No.: US 2013/0075350 A1
(43) Pub. Date: Mar. 28, 2013

(54) DEVICES FOR FACILITATING INSTALLATION AND/OR REMOVAL OF COMPONENTS IN AN EQUIPMENT RACK

(71) Applicant: Kristopher Len Raney, Austin, TX (US)

(72) Inventor: Kristopher Len Raney, Austin, TX (US)

(73) Assignee: BreakingPoint Systems, Inc.

(21) Appl. No.: 13/247,261

(22) Filed: Sep. 28, 2011

(51) Int. Cl. A47B 81/00; F16B 2/06; B23P 11/00; A47B 96/07

(52) U.S. Cl. 211/13.1; 248/219.3; 29/428

(57) ABSTRACT

A device for facilitating the movement of a component into or out of an equipment rack includes a device body, a securing system coupled to the device body and configured for releasably securing the device to a post of the equipment rack, and at least one wheel rotationally coupled to the device body. In a mounted position of the device in which the device is secured to the equipment rack post, the at least one wheel physically supports a component and facilitate movement of the component into or out of the equipment rack.

### TECHNICAL FIELD

The present disclosure relates generally to devices for facilitating the addition and/or removal of components in an equipments rack, e.g., devices configured to clamp or otherwise attach to a post of the rack and including one or more wheels for sliding a component into or out of the rack.

### BACKGROUND

Equipment racks are used for a variety of applications. For example, some racks are designed to house professional audio and video equipment, including amplifiers, effects units, interfaces, headphone amplifiers, and even small scale audio mixers. Other racks are used for computer server equipment, allowing for dense hardware configurations without occupying excessive floor space or requiring shelving. A third common use for rack-mounted equipment is industrial power, control, and automation hardware.

### SUMMARY

In accordance with the teachings of the present disclosure, disadvantages and problems associated with existing lighting systems and devices have been reduced.

According to one aspect of certain embodiments of the invention, a device for facilitating the movement of a component into or out of an equipment rack includes a device body, a securing system coupled to the device body and configured for releasably securing the device to a post of the equipment rack, and at least one wheel rotationally coupled to the device body. In a mounted position of the device in which the device is secured to the equipment rack post, the at least one wheel physically supports a component and facilitate movement of the component into or out of the equipment rack.

According to another aspect of certain embodiments of the invention, an equipment rack for housing one or more components includes a plurality of posts extending generally in a vertical direction, and a plurality of component support devices, each releasably securable to one or more of the posts. Each component support device includes a device body, a securing system coupled to the device body and configured for releasably securing the device to at least one of the equipment rack posts, and at least one wheel rotationally coupled to the device body. In a mounted position of the component support devices in which the component support devices are secured to the equipment rack posts, the wheels of the plurality of component support devices cooperate to physically support a component and facilitate movement of the component into or out of the equipment rack.

According to another aspect of certain embodiments of the invention, a method for moving a component into or out of an equipment rack in provided. A plurality of component support devices are secured to a plurality of posts of the equipment rack, each component support device including at least one rotatable wheel. A component is then supported on the wheels of the component support devices secured to the equipment rack posts. The component is then rolled into or out of the equipment rack using the wheels of the component support devices secured to the equipment rack posts. After rolling the component into or out of the equipment rack, the component support devices are released from the respective equipment rack posts.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIGS. 1A-1E illustrate an example device configured to clamp onto an equipment rack post and including a wheel for supporting and facilitating the sliding of a component into or out of the equipment rack, according to an example embodiment of the disclosure;

FIG. 2 illustrates an example device similar to the device of FIGS. 1A-1E, but including two wheels, according to an example embodiment;

FIGS. 3A and 3B illustrates an example device including a wheel and a flanged securing system for releasably securing the device to an equipment rack post, according to an example embodiment;

FIG. 4 illustrates an example device including a clamp and an adjustment system for adjustably coupling a wheel to the device, according to an example embodiment;

FIGS. 5A and 5B illustrate another example device including a clamp and an adjustment system for adjustably coupling a wheel to the device, according to another example embodiment;

FIG. 6 illustrates an example device including a wheel and a vice-grip type securing system for releasably securing the device to an equipment rack post, according to an example embodiment;

FIG. 7 illustrates an example device including a wheel and a hook-type securing system for releasably securing the device to an equipment rack post, according to an example embodiment;

FIG. 8 illustrates an example four-post equipment rack and two longitudinally-extending rail-type devices for facilitating the movement of a component into or out of the equipment rack; and

FIG. 9 illustrates an example four-post equipment rack and a laterally-extending rail-type device for facilitating the movement of a component into or out of the equipment rack.

### DETAILED DESCRIPTION

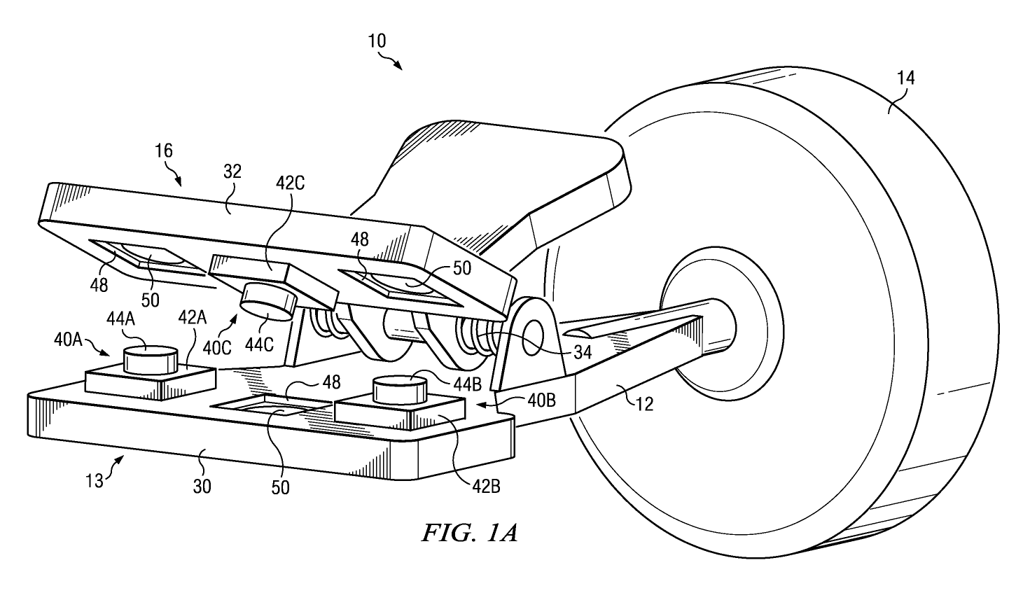

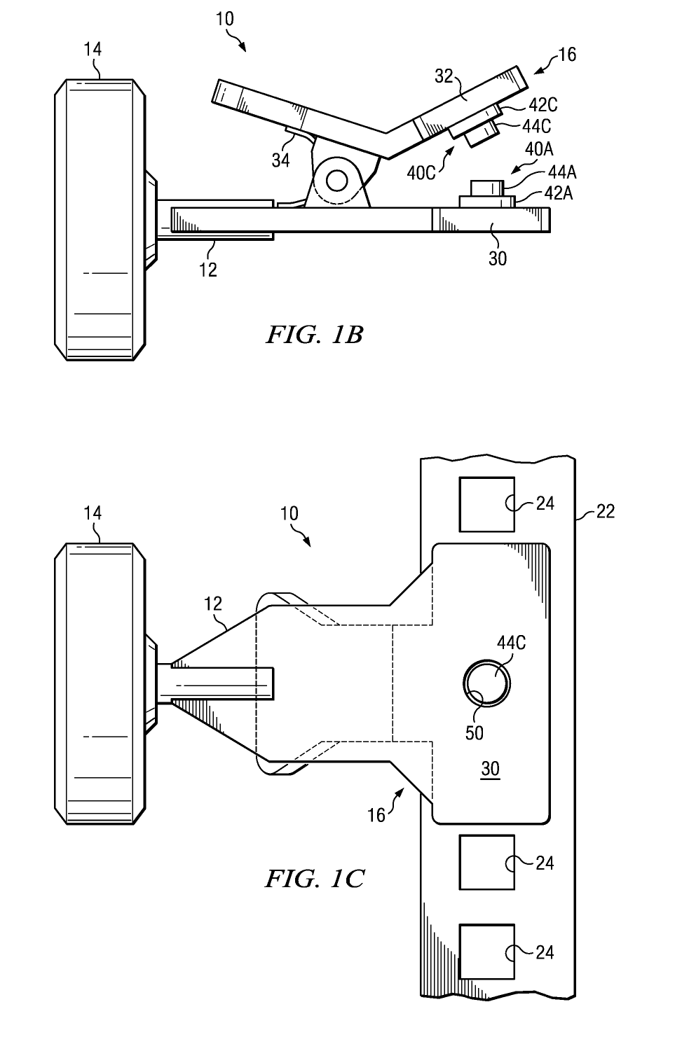

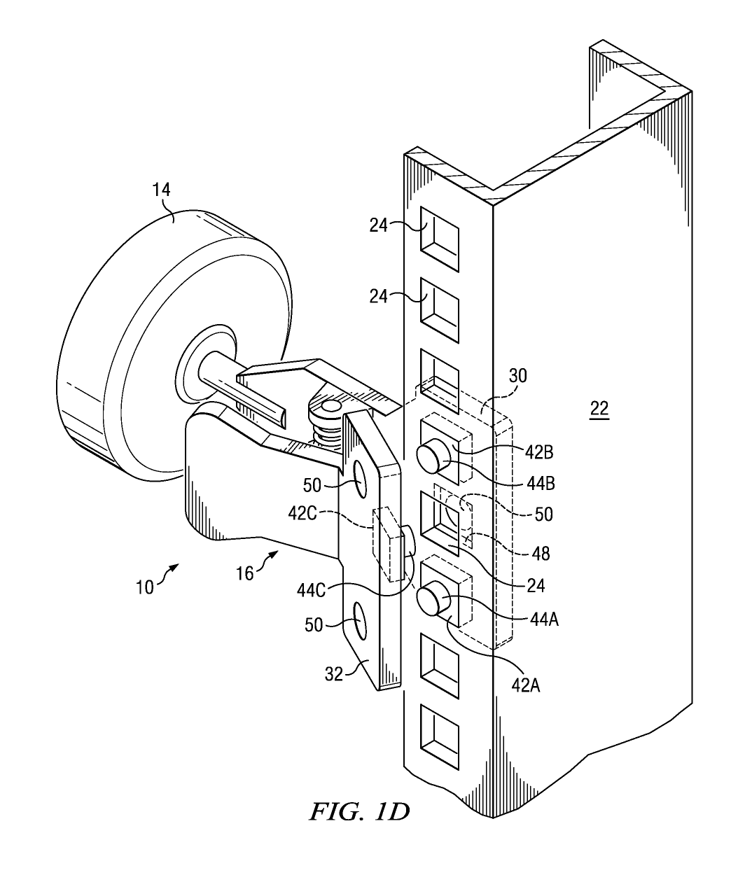

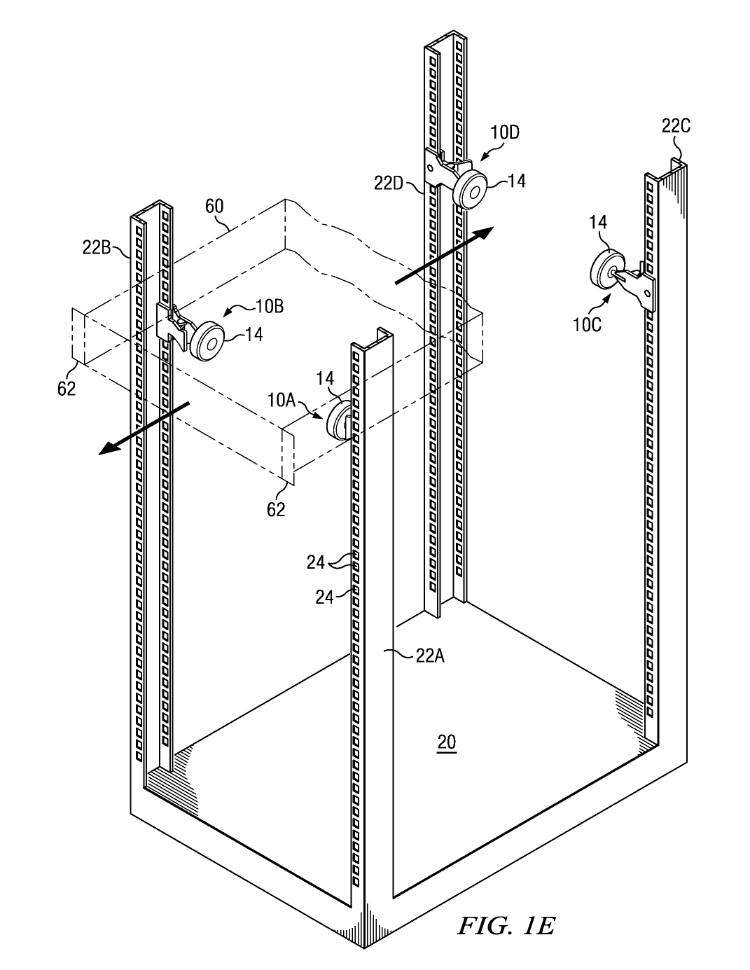

Preferred embodiments and their advantages over the prior art are best understood by reference to FIGS. 1A-9 below. However, the present disclosure may be more easily understood in the context of a high level description of certain embodiments.

FIGS. 1A-1E illustrate an example device 10 configured to clamp onto an equipment rack post and including a wheel for supporting and facilitating the sliding of a component (e.g., a server, router, hard drive, power supply, other network element, or other electronic devices) into or out of the equipment rack, according to one example embodiment. In particular, FIG. 1A shows a three-dimensional view of device 10; FIG. 1B shows a top view of device 10; FIG. 1C shows a side view of device 10 secured to a post 22 of an equipment rack 20; FIG. 1D shows a three-dimensional view of device 10 being secured to post 22; and FIG. 1E shows a three-dimensional view of a four-post equipment rack 20 having a device 10 releasably secured to each post 22.

As shown, device 10 may include a device body 12, a securing system 13 integral with or otherwise coupled to device body 12, and a wheel 14 rotationally coupled to device body 12. Securing system 13 is configured for releasably securing device 10 to a post 22 of an equipment rack 20, e.g., as shown in FIGS. 1C, 1D, and 1E. In this embodiment, securing system 13 comprises a clamp 16 moveable between unclamped, or open, position (shown in FIGS. 1A, 1B, and 1D) a clamped, or closed, position (shown in FIGS. 1C and 1E).

Clamp 16 includes a first side 30 opposing a second side 32. Clamp 16 may be spring-biased towards the clamped position, e.g., such that first side 30 and second side 32 are pressed against each other, using a spring 34 or other suitable device. Clamp 16 may include a number of protrusions 40 configured to engage with openings 24 formed in the respective equipment rack post 22. For example, in this embodiment, first side 30 includes a pair of protrusions 40A and 40B projecting toward second side 32, and second side 32 includes a single protrusion 40C projecting toward first side 30. Protrusion 40C may be located between protrusions 40A and 40B.

Protrusions 40 may be shaped and sized to engage with openings in equipment rack posts 22. In some embodiments, device 10 may include a plurality of protrusions 40 having different shapes and/or sizes corresponding to post openings of different shapes and/or sizes, such that the same device 10 may be used with multiple different types of equipment racks. In some embodiments, each protrusion 40 may include a first portion 42 having a shape and size corresponding to a first type of post opening, a second portion 44 having a shape and size corresponding to a second type of post opening different than the first type of post opening, and so on. For example, in the embodiment shown in FIG. 1A, protrusion 40A includes (a) a rectangular first portion 42A for engaging with a rectangular post opening, and (b) a circular second portion 44A projecting from rectangular first portion 42A, for engaging with a circular post opening. Similarly, protrusion 40B includes (a) rectangular portion 42B and circular portion 44B projecting from rectangular portion 42B, and protrusion 40C includes rectangular portion 42C and circular portion 44C projecting from rectangular portion 42C. Thus, device 10 may be used with both rectangular-hole equipment racks and circular-hole equipment racks. For example, FIG. 1D illustrates device 10 in use with an equipment rack post 22 having rectangular holes 24, such that rectangular protrusion 42A, 42B, and 42C engage with three rectangular holes 24.

Further, as shown in FIG. 1A, first and second sides 30 and 32 of clamp 16 may include recesses (e.g., depressions, slots, or openings) for receiving protrusions 40 when device 10 is in the clamped, or closed, position. In particular, each recess includes (a) a rectangular depression 48 for receiving a rectangular protrusion portion 42 and (b) a circular opening 50 extending from the rectangular depression 48 for receiving a circular protrusion portion 44.

Although the illustrated embodiment includes different shaped/sized protrusions aligned in a stacked manner (i.e., each circular protrusion 44 projects from a corresponding rectangular protrusions 42), in other embodiments, different protrusions 40 having different shapes and/or sizes may be arranged separate from each other in any suitable manner. For example, clamp 16 may include a row of circular protrusions aligned and a separate row of rectangular protrusions located offset from the row of circular protrusions, such that either the row of circular protrusions or the row of rectangular protrusions may be selected for use depending on the shape of the respective post openings 24.

As shown in FIG. 1D, to mount device 10 to equipment rack 20, clamp 16 may be manually opened by hand, moved into position onto a post 22, and then released, allowing clamp 16 to clamp onto the post 22 due to the bias provided by spring 34. FIG. 1E shows four devices 10A-10D removably mounted to respective posts 22A-22D of an example equipment rack 20. In some embodiments, the same device 10 may be used on any post 22 of rack 20. For example, the same device 10 shown in FIGS. 1A-1E may simply be flipped over for use on any of posts 22A-22D. Thus, device 10 may be universal with respect to the different posts 22 of a particular rack 20.

With devices 10 mounted on posts 22 as shown in FIG. 1E, the wheels 14 of the respective devices 10 are positioned to physically support a component 60 and facilitate movement of the component 60 into or out of the equipment rack 20. Thus, component 60 may be easily rolled into or out of rack 20.

For example, to insert component 60 into rack 20, devices 10A-10D may be mounted to posts 22A-22D as discussed above. A rear of central portion of component 60 may then be set down onto wheels 14A and 14B of devices 10A and 10B mounted to the front posts 22A and 22B. The component 60 may then be rolled back toward rear posts 22C and 22D and onto wheels 14C and 14D of devices 10C and 10D. Once component 60 is fully positioned in rack 20, connectors 62 provided on component 60 may be secured to posts 22A-22D, e.g., by engaging with respective openings 24 in posts 22A-22D. Once component 60 is secured to posts 22A-22D, devices 10A-10D may then be manually unclamped and removed from posts 22A-22D. In other embodiments or applications, component 60 may be installed using only a pair of devices 10 mounted to front posts 22A and 22B, i.e., without mounting devices 10 on rear posts 22C and 22D.

To remove component 60 from rack 20, devices 10A-10D may again be mounted to posts 22A-22D, such that wheels 14 are located just below the bottom surface of component 60. Connectors 62 provided on component 60 may be uncoupled from posts 22A-22D, such that component 60 is now supported by wheels 14 of devices 10A-10D. Component 60 may then be rolled forward and out of rack 20. Devices 10A-10D may then be manually unclamped and removed from posts 22A-22D. In other embodiments or applications, component 60 may be removed from rack 20 using only a pair of devices 10 mounted to front posts 22A and 22B.

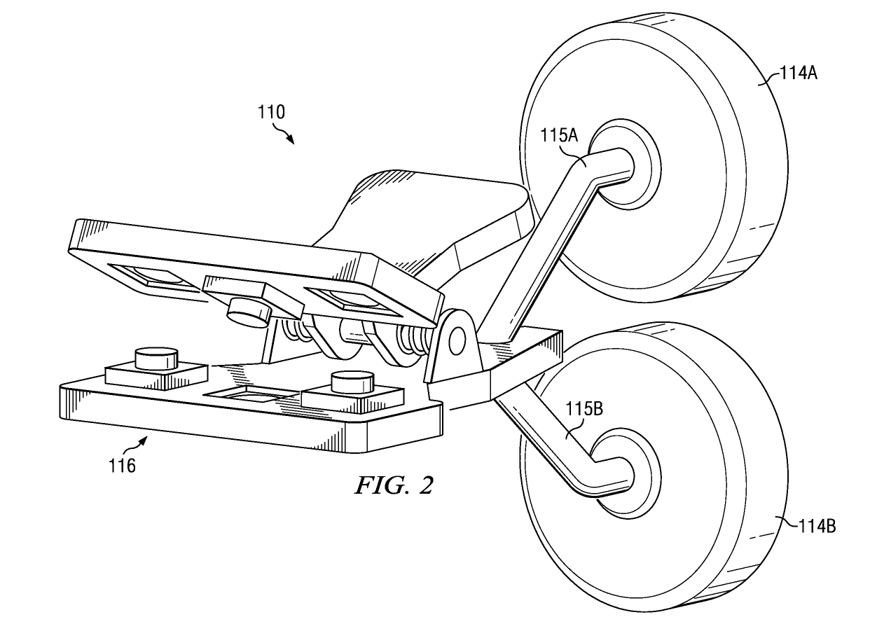

FIG. 2 illustrates an example device 110 including two wheels 114A and 114B, according to an example embodiment. Device 110 may be similar to device 10 shown in FIGS. 1A-1E, with the exception of including two wheels 114A and 114B instead of the single wheel 14. In particular, device 110 may include a clamp 116 similar to clamp 16 of device 10. To support wheels 114A and 114B, device 110 may include a pair of axles 115A and 115B. Axles 115A and 115B may be spaced apart from each other by any suitable distance to provide for any suitable spacing of wheels 114A and 114B. For example, wheels 114A and 114B may be spaced further apart to provide more stable support for component 60. In other embodiments, device 110 may include any other number of wheels, e.g., 3, 4, or more.

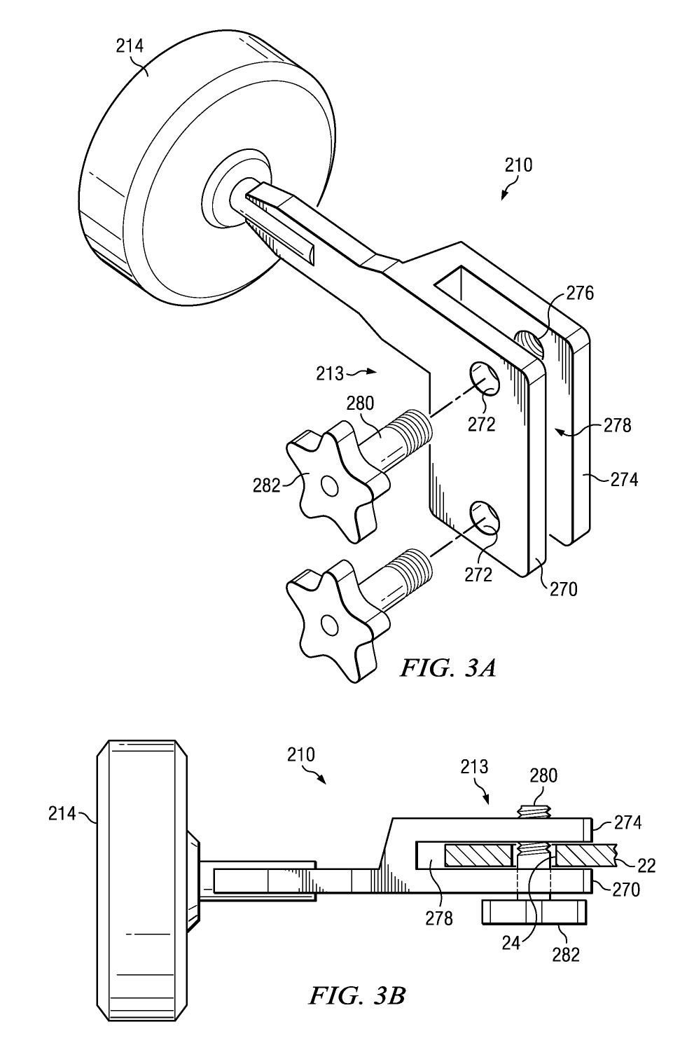

FIGS. 3A and 3B illustrates an example device 210 including a wheel 214 and a flanged securing system 213 for releasably securing device 210 to a post 22 of an equipment rack 20, according to an example embodiment. Securing system 213 may include a first flange 270 including one or more first flange openings 272 and a second flange 274 including one or more second flange openings 276, each second flange opening 276 aligned with a corresponding first flange opening 272. A gap 278 is defined between first and second flanges 270 and 274, which is configured for receiving a flange or other portion of an equipment rack post 22. Securing system 213 further includes one or more connecting pins 280, each configured to project through a first flange opening 272, an opening 24 in a post 22 received in gap 278, and a corresponding second flange opening 276. Pins 280 may be secured in any suitable manner, e.g., by a threaded engagement. Pins 280 may be configured to be inserted and removed by hand without requiring any tools. For example, each pin 280 may include a head 282 that can easily be manipulated by hand.

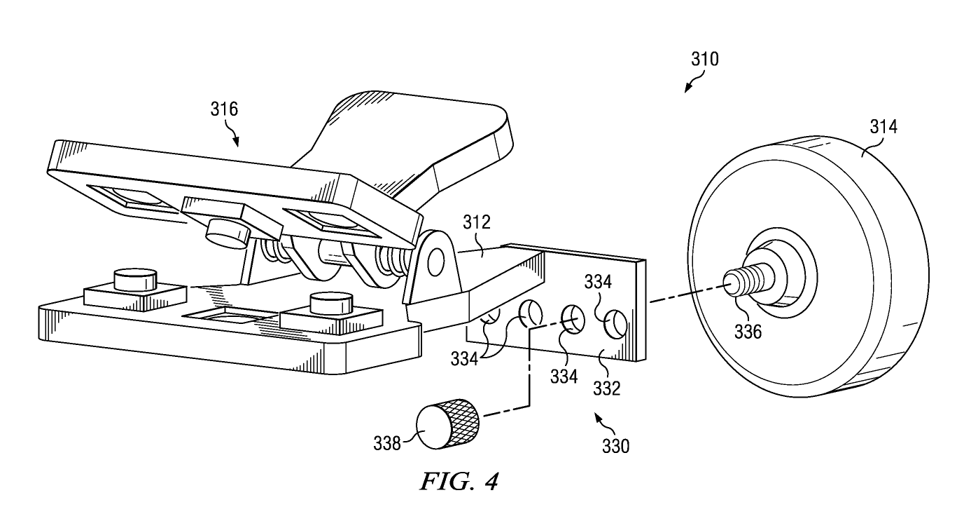

FIG. 4 illustrates an example device 310 including a body 312, a clamp 316, a wheel 314, and an adjustment system 330 for adjustably coupling wheel 314 to body 312. In particular, adjustment system 330 includes a body 332 including multiple holes 334 for receiving an axle 336 or other supporting structure of wheel 314, and a connector 338 for releasably securing axle 336 to body 332. Connector 338 may be configured for manual operation without requiring any tools. Adjustment system 330 may include any number of holes 334 offset from each other in one or more directions in order to provide multiple selectable positions for wheel 314 relative to device body 312. Adjustment system 330 may include any other system for allowing the position of wheel 314 to be selectively adjusted relative to device body 312. Adjustment system 330 may, for example, allow wheel 314 to be adjusted for use with equipment racks 20 and/or components 60 of various sizes.

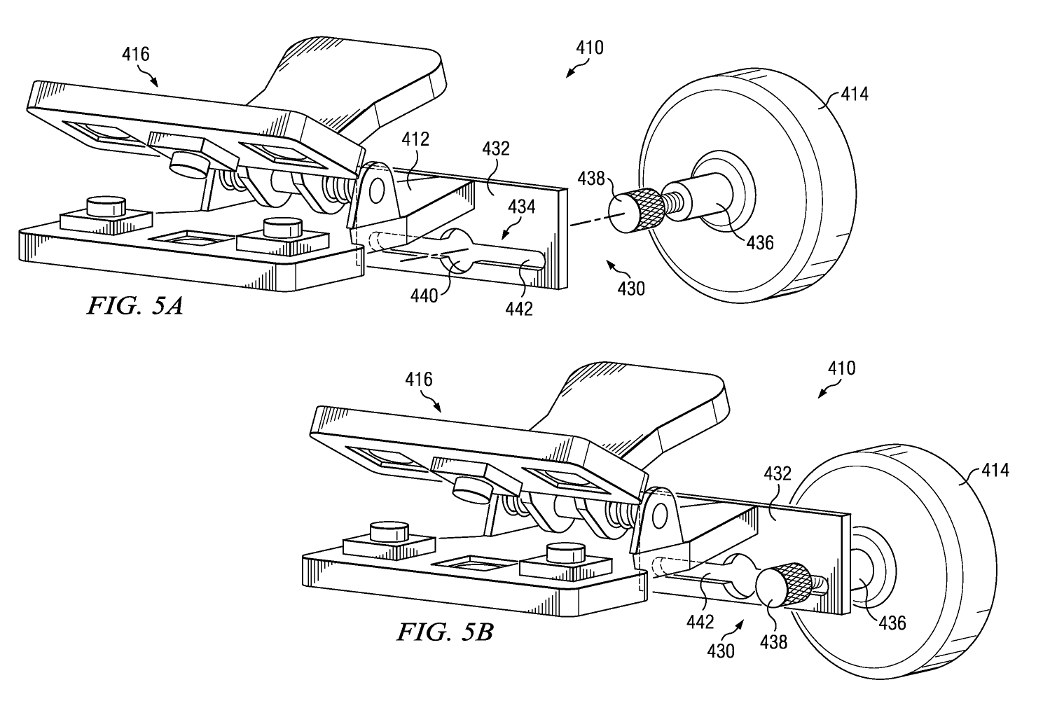

FIGS. 5A and 5B illustrate an example device 410 including a body 412, a clamp 416, a wheel 414, and an adjustment system 430 for adjustably coupling wheel 414 to body 412. In particular, adjustment system 430 includes a body 432 including a slot 434 for receiving an axle 436 or other supporting structure of wheel 414, and a connector 438 for releasably securing axle 436 to body 432. Slot 434 may include a widened portion 440 allowing connector 438 to pass through, and a narrower elongated portion 442 not allowing connector 438 to pass through, such that wheel 414 remains coupled to device body 412 during adjustment of the wheel position along the elongated slot portion 442. Connector 438 may be configured for manual operation without requiring any tools. Slot 434 may extend in any one or more directions in order to provide multiple selectable positions for wheel 414 relative to device body 412. Adjustment system 430 may, for example, allow wheel 414 to be adjusted for use with equipment racks 20 and/or components 60 of various sizes.

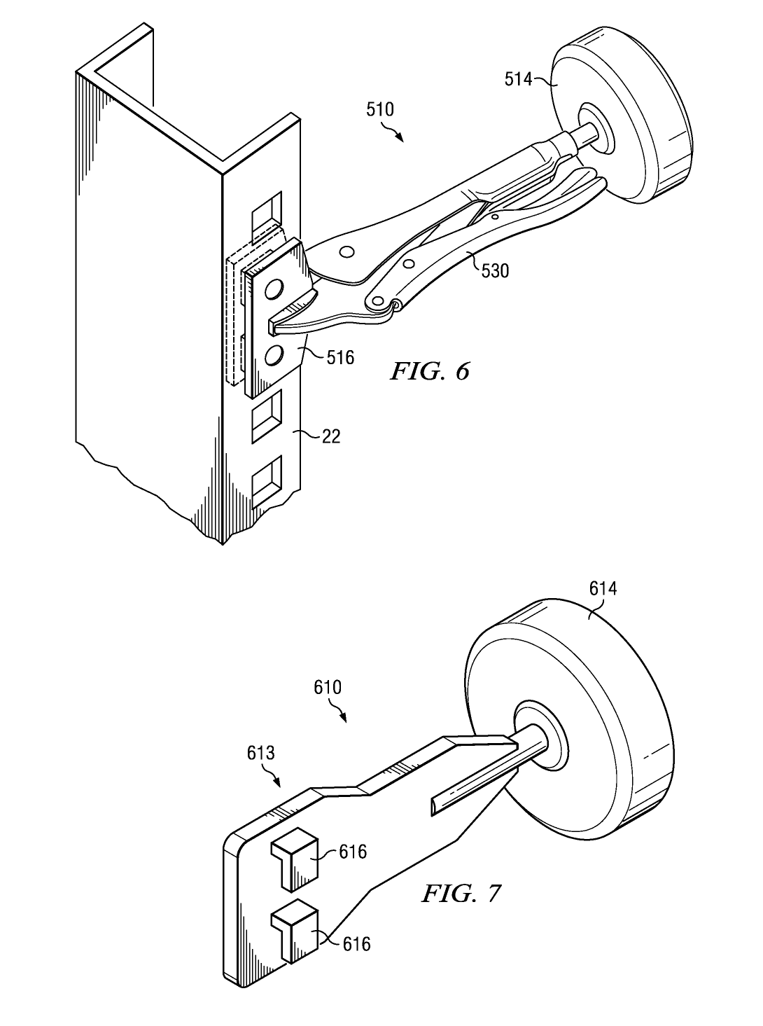

FIG. 6 illustrates an example device 510 including a wheel 514 and a vice-grip type securing system 513 for releasably securing device 510 to a post 22 of an equipment rack 20, according to an example embodiment. Securing system 513 includes a clamp 516, which may be similar to clamp 16 shown in FIGS. 1A-1E, but controlled (i.e., opened or closed) using a vice-grip type handle 530 rather than a biasing spring.

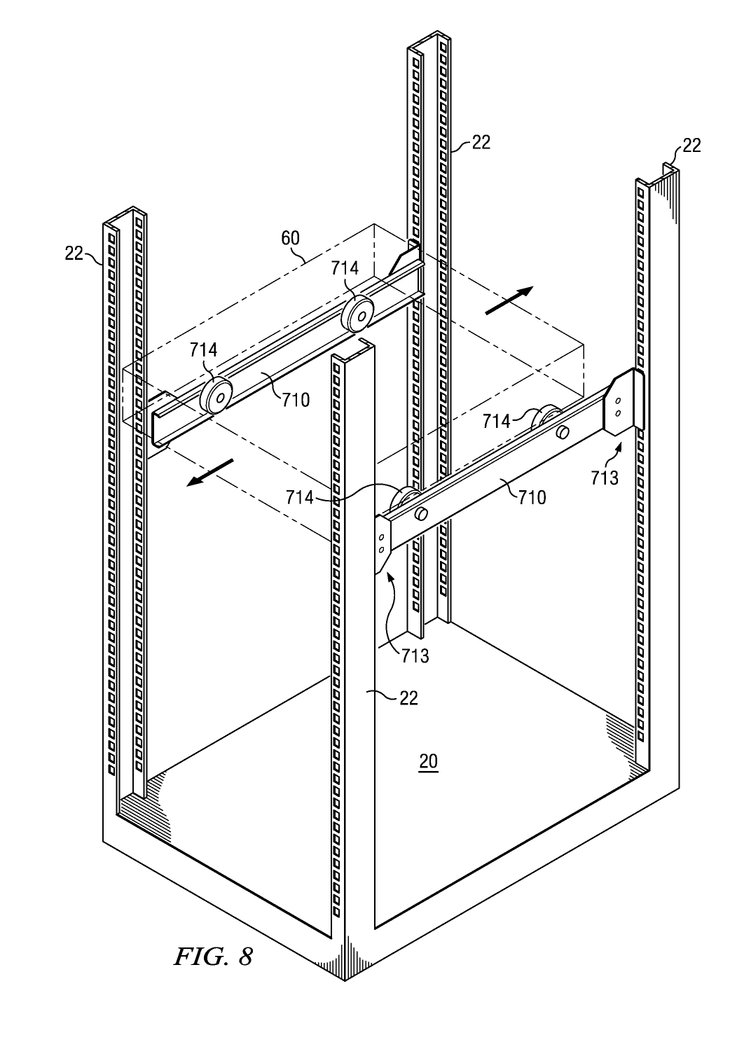

FIG. 7 illustrates an example device 610 including a wheel 614 and a hook-type securing system for releasably securing device 610 to a post 22 of an equipment rack 20, according to an example embodiment. Securing system 613 includes multiple hooks 616 configured to engage with openings 24 in a post 22. Hooks 616 may have any suitable shape and size for engaging with openings 24.

FIG. 8 illustrates an example four-post equipment rack 20, and two rail-type devices 710 for facilitating the installation or removal of a component 60 relative to rack 20. Each device 710 include a rail 702 configured to extend in a longitudinal direction between, and be releasably secured to, two posts 22 on the same lateral side of the rack 20. Each rail 710 may be releasably secured to the respective posts 22 in any suitable manner using any suitable securing systems 713, e.g., any of the securing systems discussed herein or any other suitable systems. In the illustrated embodiment, each device 710 includes a pair of wheels 714 rotatably mounted to the rail 714 for physically supporting and facilitating the installation or removal of a component 60 relative to rack 20. In other embodiments, each device 710 may include any other number (e.g., one, three, four, or more) wheels 714 mounted to the rail 714.

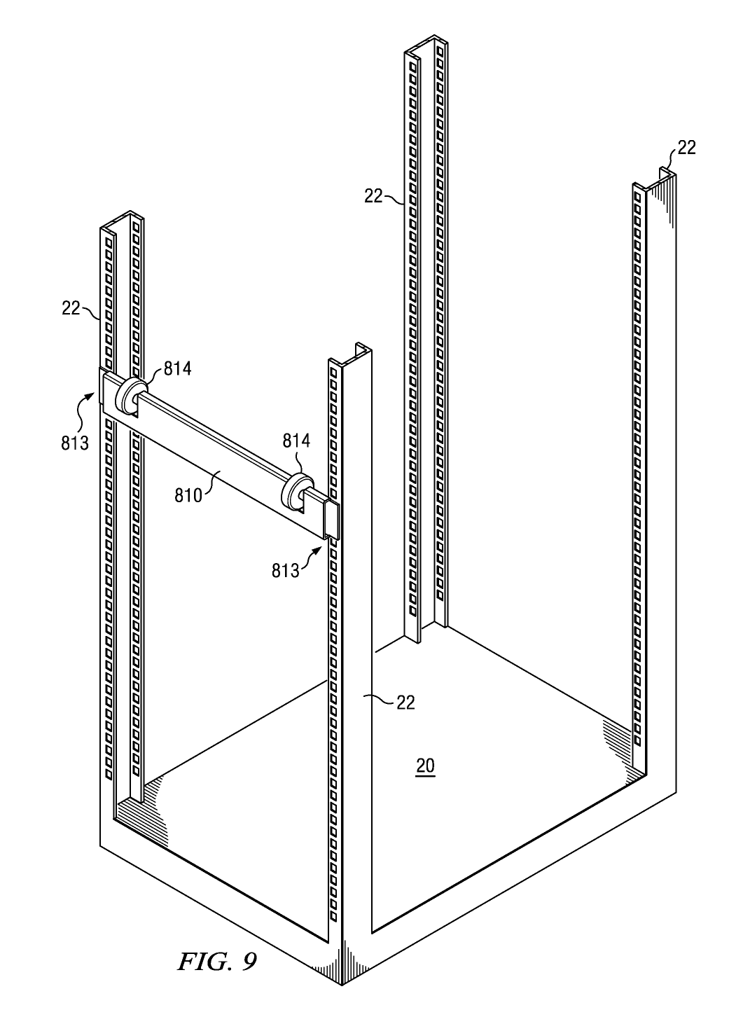

FIG. 9 illustrates an example four-post equipment rack 20, and a rail-type device 810 for facilitating the installation or removal of a component 60 relative to rack 20. Unlike rail-type device 710 shown in FIG. 8, rail-type device 810 includes a rail 802 configured to extend in a lateral direction between, and be releasably secured to, the front two posts 22 of rack 20. Rail 810 may be releasably secured to the respective posts 22 in any suitable manner using any suitable securing systems 813, e.g., any of the securing systems discussed herein or any other suitable systems. In the illustrated embodiment, each device 810 includes a pair of wheels 814 rotatably mounted to the rail 814 for physically supporting and facilitating the installation or removal of a component 60 relative to rack 20. In other embodiments, each device 810 may include any other number (e.g., one, three, four, or more) wheels 814 mounted to the rail 814. In some embodiments or applications, a single rail-type device 810 may be used for installing or removing a component 60. In other embodiments or applications, a pair of rail-type device 810 may be used for installing or removing a component 60, with the second device 810 being releasably secured to the rear two posts 22 of rack 20.

Although the disclosed embodiments are described in detail in the present disclosure, it should be understood that various changes, substitutions and alterations can be made to the embodiments without departing from their spirit and scope.

What is claimed is:

1. A device for facilitating the movement of a component into or out of an equipment rack, comprising:
a device body;
a securing system coupled to the device body and configured for releasably securing the device to a post of the equipment rack;
at least one wheel rotationally coupled to the device body;
wherein in a mounted position of the device in which the device is secured to the equipment rack post, the at least one wheel is configured to physically support a component and facilitate movement of the component into or out of the equipment rack.

2. The device according to claim 1, wherein the securing system comprises a clamp moveable between a clamped position for securing the device to the equipment rack post and an unclamped position for removing the device from the equipment rack post.

3. The device according to claim 2, wherein the clamp is spring-biased towards the clamped position.

4. The device according to claim 2, wherein the clamp comprises:
a first side and a second side opposing the first side; and
at least one protrusion provided on at least one of the first and second sides of the clamp, the one or more protrusions configured to be received in at least one opening provided in the equipment rack post.

5. The device according to claim 2, wherein the clamp comprises:
a first side including at least one first protrusion configured to be received in at least one first opening provided in the equipment rack post; and
a second side facing the first side and including at least one second protrusion configured to be received in at least one second opening post provided in the equipment rack post.

6. The device according to claim 2, wherein the clamp comprises:
a first protrusion having a shape and size corresponding to a first type of post opening; and
a second protrusion having a shape and size corresponding to a second type of post opening different than the first type of post opening.

7. The device according to claim 6, wherein the second protrusion protrudes from the first protrusion.

8. The device according to claim 2, wherein the clamp comprises:
a first side and a second side opposing the first side; and
at least one first protrusion provided on the first side of the clamp and protruding toward the second side of the clamp;
at least one second protrusion provided on the second side of the clamp and protruding toward the first side of the clamp.

9. The device according to claim 8, wherein each of the first and second protrusions includes:
a first portion having a shape and size corresponding to a first type of post opening; and
a second portion having a shape and size corresponding to a second type of post opening different than the first type of post opening.

10. The device according to claim 1, wherein the device includes at least two wheels rotationally coupled to the device body.

11. The device according to claim 1, wherein the securing system comprises:
a flange including at least one flange opening; and
at least one pin, each pin configured for insertion through a flange opening and a corresponding opening in the equipment rack post.

12. The device according to claim 11, wherein each pin engages with a corresponding flange opening by a threaded engagement.

13. The device according to claim 1, wherein the securing system comprises:
a first flange including at least one first flange opening;
a second flange including at least one second flange opening, each second flange opening aligned with a corresponding first flange opening;
a gap defined between the first and second flanges, the gap configured for receiving a portion of the equipment rack post,
at least one pin, each pin configured for insertion through a first flange opening, an opening in the equipment rack post received in the gap, and a corresponding second flange opening.

14. The device according to claim 1, wherein each of the at least one wheel is adjustably coupled to the device body such that an axis of rotation of the wheel is selectively movable between multiple positions relative to the device body.

15. The device according to claim 1, wherein the securing system comprises:
a clamp; and
a vice grip handle for controlling the clamp.

16. The device according to claim 1, wherein:
the device body comprises a rail configured to extend between two equipment rack posts;
the securing system is configured for releasably securing the device to the two equipment rack posts;
at least two wheels are rotationally coupled to the device body.

17. The device according to claim 16, wherein the rail is configured to extend in a longitudinal direction between two posts on the same lateral side of the equipment rack.

18. The device according to claim 16, wherein the rail is configured to extend in a lateral direction between two posts at the front of the equipment rack or between two posts at the rear of the equipment rack.

19. An equipment rack for housing one or more components, the equipment rack comprising:
a plurality of posts extending generally in a vertical direction;
a plurality of component support devices, each releasably securable to one or more of the posts, each component support device including:
a device body;
a securing system coupled to the device body and configured for releasably securing the component support device to at least one of the equipment rack posts; and
at least one wheel rotationally coupled to the device body;
wherein in a mounted position of the component support devices in which the component support devices are secured to the equipment rack posts, the wheels of the plurality of component support devices physically support a component and facilitate movement of the component into or out of the equipment rack.

20. A method for moving a component into or out of an equipment rack, the method comprising:
securing a plurality of component support devices to a plurality of posts of the equipment rack, each component support device including at least one rotatable wheel;
supporting a component on the wheels of the component support devices secured to the equipment rack posts;
rolling the component into or out of the equipment rack using the wheels of the component support devices secured to the equipment rack posts; and
after rolling the component into or out of the equipment rack, releasing the component support devices from the respective equipment rack posts.
